(19) United States
(12) Patent Application Publication
(10) Pub. No.: US 2014/0014495 A1
(43) Pub. Date: Jan. 16, 2014

(54) System and Process for Functionalizing Graphene

(71) Applicant: High Temperature Physics, LLC, Novato, CA (US)

(72) Inventors: Robert Wayne Dickinson, San Rafael, CA (US); Douglas Paul DuFaux, Orchard Park, NY (US); Maurice Yvon Belisle, Buffalo, NY (US)

(73) Assignee: High Temperature Physics, LLC, Novato, CA (US)

(21) Appl. No.: 13/964,844

(22) Filed: Aug. 12, 2013

Related U.S. Application Data
(63) Continuation-in-part of application No. 13/864,080, filed on Apr. 16, 2013.
Application No. 13/864,080 is a continuation-in-part of application No. 13/237,766, filed on Sep. 20, 2011, now Pat. No. 8,420,042.
Application No. 13/237,766 is a continuation-in-part of application No. 13/090,053, filed on Apr. 19, 2011, now Pat. No. 8,377,408.
(60) Provisional application No. 61/682,182, filed on Aug. 10, 2012.

(51) Int. Cl. C01B 31/04

(52) U.S. Cl. CPC C01B 31/04
USPC 204/157.44; 422/186.05; 204/157.65; 204/157.64

(57) ABSTRACT

System and process in which graphene, which may be produced on a commercial scale, is highly purified, then functionalized in a vertical plasma reactor which can also deagglomerate and/or delaminate the graphene, as well as separating or classifying the functionalized graphene particles according to size. In one disclosed embodiment, the graphene is produced by combustion of magnesium (Mg) and carbon dioxide (CO₂) in a highly exothermic reaction. The graphene is separated from the other reaction products and purified in a series of washing, heating, and drying steps, following which it is functionalized and otherwise processed in the plasma reactor.

### RELATED APPLICATIONS

Provisional Application No. 61/682,182, filed Aug. 10, 2012, the priority of which is claimed.

Continuation-in-part of application Ser. No. 13/864,080, filed Apr. 16, 2013, which is a continuation-in-Part of application Ser. No. 13/237,766, filed Sep. 20, 2011, now U.S. Pat. No. 8,420,042, a continuation-in-part of application Ser. No. 13/090,053, filed Apr. 19, 2011, now U.S. Pat. No. 8,377,408.

### BACKGROUND OF THE INVENTION

1. Field of Invention

This invention pertains generally to the production of carbon nanomaterials and, more particularly, to a system and process for functionalizing graphene.

2. Related Art

Carbon graphenes have a number of unique and desirable qualities, including extraordinary surface area, high electrical conductivity and capacitance, high thermal and mass transfer capability, magnetic properties, and extraordinary values of tensile strength and modulus of elasticity. With such attributes, carbon graphene structures are attractive to a number of important technologies and markets, including electrolytic storage media for lithium ion batteries and ultra capacitors, facilitated transport membranes for micro filtration, catalytic substrate materials, heat transfer materials for use in cooling light-emitting diodes (LEDs) and other applications, high frequency semiconductors capable of operating at frequencies as high as 100 gigahertz or more, hydrogen storage, conductive materials for flatscreen and liquid crystal displays (LCDs), and strengthening agents for advanced materials in wind turbines and automobiles.

There are a number of known methods for producing graphenes, including chemical vapor deposition, epitaxial growth, micro-mechanical exfoliation of graphite, epitaxial growth on an electrically insulating surface, colloidal suspension, graphite oxide reduction, growth from metal-carbon melts, pyrolysis of sodium ethoxide, and from nanotubes. However, these processes have limitations and disadvantages, including a dependency on relatively scarce, highly crystalline graphite feedstock, high cost, and limited scalability. Because of these limitations, the known methods may not be capable of providing a dependable supply of low cost graphenes with high volumes of production, and none of them appears to be suitable for producing graphenes on a commercial scale.

### OBJECTS AND SUMMARY OF THE INVENTION

It is, in general, an object of the invention to provide a new and improved system and process for functionalizing graphene.

Another object of the invention is to provide a system and process of the above character which overcome the limitations and disadvantages of systems and processes heretofore provided.

These and other objects are achieved in accordance with the invention by providing a system and process in which graphene is highly purified, then functionalized in a vertical plasma reactor which can also deagglomerate and/or delaminate the graphene, as well as separating or classifying the functionalized graphene particles according to size. In some of the disclosed embodiments, the graphene is produced by combustion of magnesium (Mg) and carbon dioxide (CO₂) in a highly exothermic reaction. The graphene is separated from the other reaction products and purified in a series of washing, heating, and drying steps, following which it is functionalized and otherwise processed in the plasma reactor.

### BRIEF DESCRIPTION OF THE DRAWINGS

FIG. 1 is a flow chart of one embodiment of a process for producing and processing graphene in accordance with the invention.

FIG. 2 is a flow chart of an embodiment of a process for producing graphene that is purified and functionalized in accordance with the invention.

FIG. 3 is a flow chart of one embodiment of a process for purifying graphene for functionalization in accordance with the invention.

FIG. 4 is a flow chart of another embodiment of a process for purifying graphene for functionalization in accordance with the invention.

FIG. 5 is a block diagram of one embodiment of a system for purifying graphene for functionalization in accordance with the invention.

FIG. 6 is a block diagram illustrating the use of a pusher oven in the purification of graphene for functionalization in accordance with the invention.

FIG. 7 is a vertical sectional view, somewhat schematic, of one embodiment of a reactor for functionalizing graphene in accordance with the invention.

### DETAILED DESCRIPTION

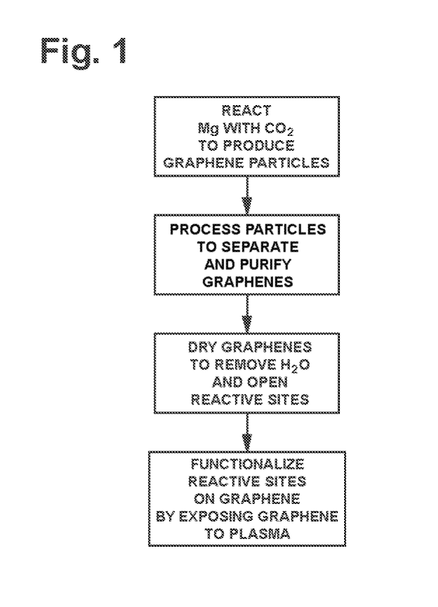

In the embodiment illustrated in FIG. 1, the process for producing and processing graphene includes the steps of reacting magnesium (Mg) and carbon dioxide (CO2) together to produce the graphene, separating graphene particles from other reaction products and purifying the graphene particles, drying the graphene particles to remove water (H2O) and open reactive sites, and functionalizing the reactive sites in an ionized gas plasma.

One particularly preferred process for producing graphene is described in detail in U.S. Pat. Nos. 8,377,408 and 8,420,042, the disclosures of which are incorporated herein by reference. In that process, magnesium and carbon dioxide are combusted together in a highly exothermic reaction to produce carbon and magnesium oxide (MgO) products which are then separated and purified. This process is highly scalable and capable of producing graphenes of high purity and quality on a commercial basis.

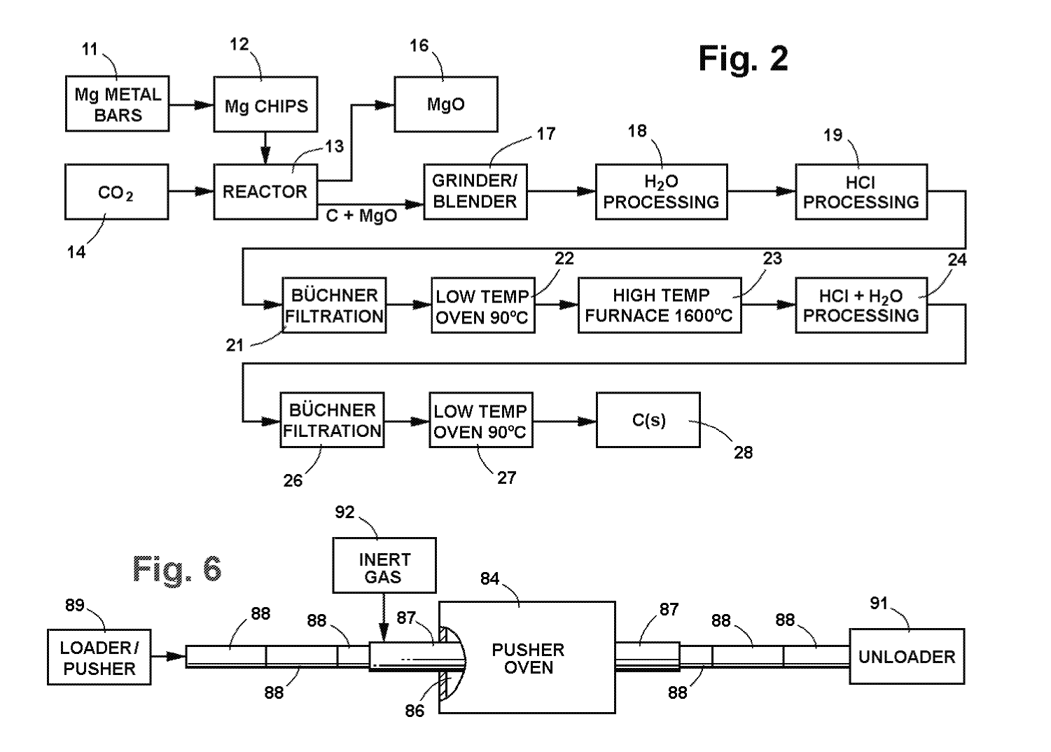

FIG. 2 illustrates an embodiment of the Mg CO2 process in which magnesium bars 11 are machined to produce chips 12 which are fed to a reactor 13 where they are combusted with CO2 from a liquid CO2 tank 14 in a highly exothermic reaction that produces temperatures which typically can range from about 1000° F. (537° C.) to about 7000° F. (3872° C.). MgO produced by the reaction is captured in a collector 16 and converted to magnesium which can be recycled and used in the reaction.

The reaction also produces a mixture of carbon and MgO products which are delivered to a grinder or blender 17 where they are reduced to finer particles and prepared for further processing. The ground-up particles are washed first with deionized water 18 and then with hydrochloric acid (HCl) 19. The carbon graphenes are inert to HCl, but the HCl reacts with unreacted magnesium in the mixture as well as the dissolved MgO and Mg(OH2) to form magnesium chloride (MgCl2) and water (H2O).

The solution of carbon graphenes and MgCl2 is filtered in a Büchner vacuum filter 21 to separate the graphenes from the MgCl2. The graphenes are dried at a temperature on the order of 90° C. in a low temperature oven 22, then further purified in a high temperature furnace 23 operating at a temperature on the order of 1600° C. The graphene particles are then once again washed with HCl and water at 24, then further separated in a second Büchner vacuum filter 26. The graphene particles from the second filter are dried in a low temperature oven 27 and collected at 28.

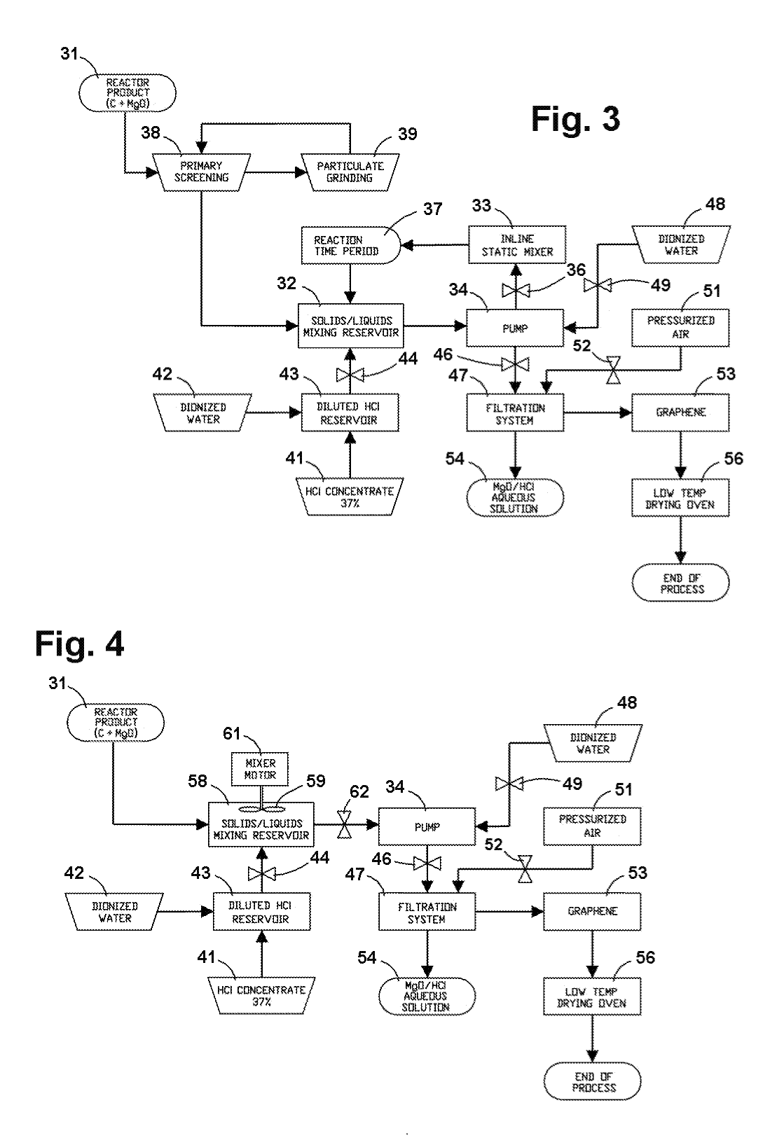

Another embodiment of a process for separating and purifying the carbon and Mg reaction products is illustrated in FIG. 3. This process includes acid washing, filtering, and drying stages. The acid washing is done in a loop that includes a mixing reservoir 32, a static inline mixer 33, and a pump 34, with a valve 36 between the pump and the mixer and a reaction period timer 37 which controls the length of the cycle.

Prior to acid washing, reaction products 31 are screened and ground to provide particles of the desired size for further processing. Thus, the products first go through a screening stage 38, and particles that are too big to pass through the screen are delivered to a grinding stage 39 where they are ground into finer particles which are fed back to the screen. The particles which pass through the screen are delivered to mixing reservoir 32. In applications where the reactor products do not require screening and grinding, those steps can be omitted, and the reactor products can be fed directly to the mixing reservoir.

The acid washing is done with a diluted HCl solution that is prepared from concentrated HCl and deionized water from tanks 41, 42 and stored in a holding reservoir 43, with a valve 44 between the holding and mixing reservoirs.

The acid washing process is initiated by opening valve 44 and introducing the diluted HCl solution into the mixing reservoir. When the desired amount of solution has been introduced, valve 44 is closed, valve 36 is opened, and pump 34 is turned on to circulate the aqueous solution from the mixing reservoir through inline static mixer 33 and back to the mixing reservoir. The reactor product particles are introduced into the circulating solution and mixed with it as the solution continues to circulate around the loop that includes the reservoir, pump, and mixer.

Upon completion of the acid washing cycle, the aqueous solution and graphene particles are pumped through another valve 46 to a filtration system 47 where the graphene particles are separated from the solution. In a presently preferred embodiment, the filtration system includes a Büchner vacuum filter, and the pumping continues until the majority of the solution has been drained from the reservoir and mixer.

Deionized water from a tank 48 is then delivered to the pump through a valve 49 and flushed through the filtration system to neutralize the aqueous solution in it. Once the solution has been neutralized, water valve 49 is closed, the pump is turned off, and valve 46 is also closed.

Pressurized air from a tank 51 is then introduced into the filtration system through an air valve 52 to air dry the graphene particulate in the filter. When the drying operation has been completed, the filter element and the dried graphene particles 53 are removed from the filter housing, and the aqueous MgO/HCl solution 54 is drained from the housing.

The air dried graphene is then placed in a low temperature drying oven 56 to complete the drying process and ensure the removal of all moisture from it.

The aqueous MgO/HCl solution produced by the process can be used in producing MgCl2 that can be used as feed stock for an electrolytic cell to make magnesium metal.

The embodiment of FIG. 4 is generally similar to the embodiment of FIG. 3, and like reference numerals designate corresponding elements and steps in the two. In this embodiment, however, the acid washing process is done in a mixing reservoir 58, rather than circulating the aqueous solution and graphene particles through a separate mixer. The mixing is done by mixing blades 59 which are driven by a motor 61. Communication between mixing reservoir 58 and the pump and filtration system is controlled by a valve 62 which is connected between the reservoir and the pump.

In the embodiment of FIG. 4, the reactor product 31 is shown as being fed directly to the mixing reservoir, rather than going through the screening and grinding stages. However, if the feedstock particles need to be reduced in size, the chips can be screened and ground as in the embodiment of FIG. 3.

The acid washing cycle in this embodiment is initiated by opening valve 44 to admit the dilute HCl solution to the mixing reservoir, then closing the valve and turning on the mixer. The reactor product particles are then introduced into the mixer, and the mixing continues until the acid wash process is completed.

When the acid wash is completed, valve 62 is opened, and the pump is turned on to transfer the aqueous solution and graphene particles from the mixer reservoir to the filtration system. As in the previous embodiment, the pumping continues until the majority of the solution has been drained from the reservoir. The filter is then flushed with deionized water from tank 48, after which valve 62 is closed, the pump is turned off, and the graphene particles in the filter are dried with pressurized air from air tank 51. The air dried graphene particles are removed from the filter and placed in low temperature drying oven 56 to complete the moisture removal process.

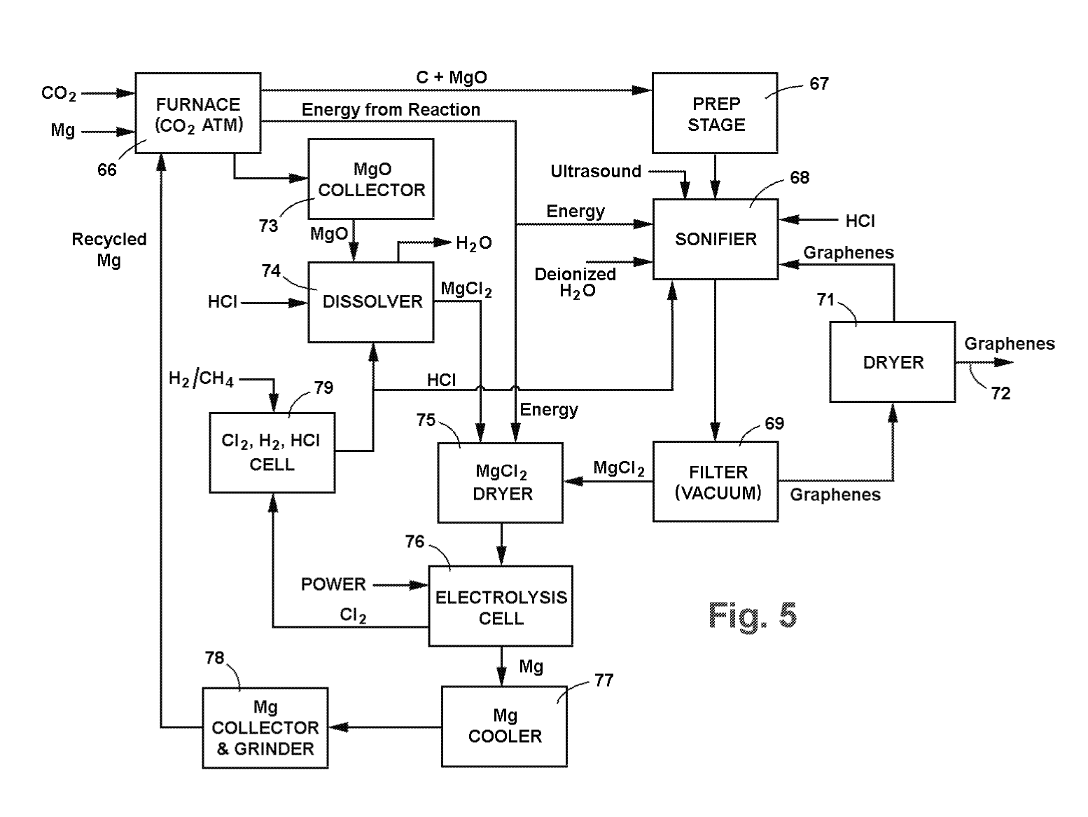

In the embodiment of FIG. 5, CO2 and magnesium are introduced into a reactor furnace 66 where they are combusted together in a highly exothermic oxidation-reduction reaction, as discussed above, producing a mixture of carbon and magnesium oxide (MgO) products which are delivered to a preparation stage 67 where they are ground into finer particles and prepared for further processing. These particles are processed ultrasonically in deionized water in a sonifier 68, then washed in hydrochloric acid (HCl). The carbon graphenes are inert to HCl, but the HCl reacts with unreacted magnesium in the mixture as well as the dissolved MgO and Mg(OH2) to form magnesium chloride (MgCl2) and water (H2O).

The aqueous MgCl2 solution and carbon graphenes are filtered in a vacuum filter 69 to separate the graphenes from the MgCl2. The graphenes are dried in a dryer 71 and recycled back through the sonification, filter, dryer, and heating stages to further purify them. The number of times the graphenes are recycled is determined by the level of purity desired, and is typically on the order of three or four times per cycle batch. When the purification process is completed, the graphenes are discharged through a product line 72.

Magnesium oxide (MgO) produced by the Mg—CO2 reaction is collected and converted to magnesium which is recycled for use in the reaction. Thus, gaseous MgO from the reactor is collected and solidified in a collector 73, then washed with HCl and converted to MgCl2 in a dissolver 74. This MgCl2 is dried in a dryer 75 along with the MgCl2 that was separated from the carbon graphenes in filter 69. The dried MgCl2 is then separated into magnesium and chlorine by electrolysis in a cell 76. The magnesium is cooled in a cooler 77, then collected and ground into finer particles, e.g. 400 Mesh, in a collector and grinder 78. The magnesium particles from the grinder are fed back to reactor 66 and used in the combustion process. Although grinding is used in this particular embodiment, the magnesium can also be reduced to finer particles by other means such as cutting or cooling small droplets from a melt.

In addition to the reaction products, the combustion of CO2 and magnesium also produces substantial amounts of heat and energy which are captured and utilized in other steps of the process, such as sonification and drying, or otherwise.

Chlorine, hydrogen, and HCl utilized in the process are provided by a cell 79 to which hydrogen (H2) and methane (CH4) are supplied along with the chlorine from electrolysis cell 76.

The purified graphene from the embodiments of FIGS. 2-5 is further purified in a high temperature pusher oven 84. As illustrated in FIG. 6, the oven has a heating cavity 86 and a graphite tube 87 which passes through the cavity. The graphite particles to be treated are placed in graphite boats 88 which are pushed through the tube between a loader/pusher station 89 and an unloading station 91 at opposite ends of the tube. The interior of the tube and the boats within the tube are flooded with an inert gas such as argon (Ar) or nitrogen (N) from a pressurized source 92 to maintain an inert gas atmosphere within the boats and tube to prevent combustion of the carbon in the boats.

The pusher oven is electrically operated and is typically operated at temperatures ranging from about 800° C. to about 1600° C. The boats are pushed through the tube in stepwise fashion, and the residence time of the boats in the oven cavity can be varied from about one half hour to as many hours as desired. With a residence time of about 4 hours, for example, the purity level of the graphene product is greater than 99 percent.

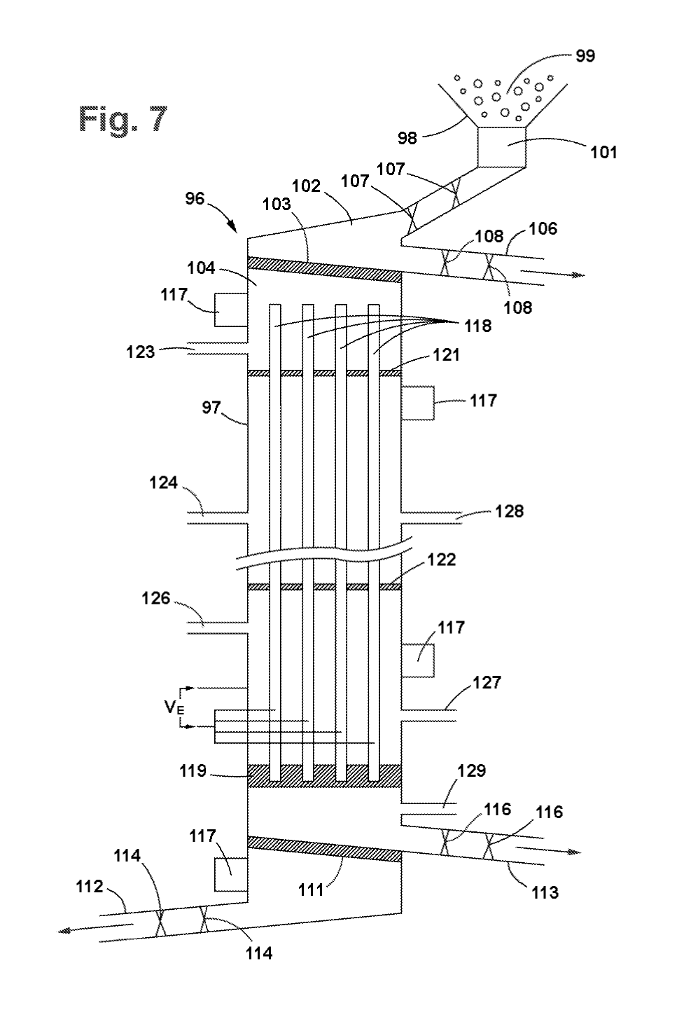

The highly purified graphene particles from the pusher oven are functionalized in a plasma reactor 96 where they can also be deagglomerated and/or delaminated, and separated or classified according to size. As illustrated in FIG. 7, the reactor has a vertically extending cylindrical housing or tower 97 which is fabricated of a suitable material such as stainless steel and might typically have a height or length on the order of 100 feet and a diameter on the order of about 2-6 inches. The tower can, however, be of any suitable dimensions and can, for example, range in height from about 10 feet, or less, to about 500 feet, or more. At the upper end of the tower, there is a hopper 98 for receiving the purified graphene material 99 and a grinder 101 for reducing that material to a desired particle size, such as 200 microns, for example.

An inlet section 102 extends between the bottom of the grinder and the top of the tower, with a filter 103 at the bottom of the inlet section for passing particles of the desired size to a reactor chamber 104 within the tower. The inlet section includes a discharge chute 106 for particles that are too large to pass through the filter. The inlet section and discharge chute are provided with vacuum interlocks 107, 108 which allow the particles to pass while maintaining a vacuum within the reactor.

A second filter screen 111 is provided at the lower end of the tower with a first outlet 112 below the screen for particles passing through the screen and a second outlet 113 above the screen for particles that do not pass through it. Vacuum interlocks 114, 116 allow the particles to pass through the outlets while maintaining the vacuum within the reactor. Output filter 111 is chosen in accordance with the size of the particles to be produced and corresponds generally to the size of input filter 103. Thus, for example, with a 200 micron input filter, the output filter might have a size of 300 microns.

Vibrators 117 are mounted on the outer side of tower wall 97 to prevent the graphene material from adhering to the chamber walls.

Plasma generating electrodes 118 extend vertically within the reactor chamber and are supported by a lower electrode support 119, an upper electrode support 121, and a middle electrode support 122. A DC voltage VE on the order of 15 KV to 35 KV is applied between the electrodes and the reactor wall 97.

Inlet ports 123, 124, and 126 are provided for the introduction of gases for ionization in the chamber to form a plasma for functionalizing the graphene particles. The gases are chosen in accordance with the desired functions, and different gases can be used in different regions of the chamber.

Suitable gases for functionalizing the graphene include oxygen, nitrogen, water vapor, hydrogen peroxide, carbon dioxide, ammonia, ozone, carbon monoxide, silane, dimethysilane, trimethylsilane, tetraetoxysilane, hexamethyldisioxane, chloro-silanes, fluoro-silanes, ethylene diamine, maleic anhydride, arylamine, acetylene, methane, ethane, propane, butane, ethylene oxide, hydrogen, air, sulfur dioxide, hydrogen, sulfonyl precursors, argon, helium, alcohols, methanol, ethanol, propanol, carbon tetrafluoride, carbon tetrachloride, carbon tetrabromide, chlorine, fluorine, bromine, and combinations thereof.

With inlet ports 123, 124, and 126 being spaced apart along the length of the reactor, different gases can be introduced through different ones of the ports and ionized to form different plasmas in different regions of the reactor. This allows the graphene particles to be functionalized in different ways, with different gases becoming attached, or adhering, to the reactive sites as the particles drop or fall through the chamber. Examples of gases in different functional groups that can be used in functionalizing the graphene are listed in the table below.

TABLE 1

| Functional | |
|---|---|
| Group | Gases |
| Hydroxyl | Water vapor, alcohols such as methanol, ethanol, propanol |
| Carboxyl | Formic acid, acetic acid, carbon dioxide, oxygen, hydrogen |
| | peroxide |
| Carbonyl | Oxygen |
| Anhydride | Maleic anhydride |
| Epoxy | Ozone |
| Halogens | Fluorine, chlorine, bromine, carbon tetrachloride, |
| | chloromethane |
| Aryl | Benzene, toluene |
| Alkyl | Methane, ethane, propane |
| Amine | Nitrogen, ammonia, methylamine, hydrogen |

A vacuum pump (not shown) is connected to a vacuum port 127 for maintaining a partial vacuum in the reactor chamber, and cryogenic gases can be introduced into the chamber through a cryogenic port 128 to cool the reactor and deagglomerate graphene clusters, if necessary. With the plasma functionalization process, deagglomeration can increase the surface area of the graphene that is exposed to the plasma and functionalized. In applications where deagglomeration is not required, the cryogenic port can be omitted, if desired.

Another optional feature is a liquid injection port 129 which is positioned toward the lower end of the reaction chamber and can be utilized for introducing liquid into the lower portion of the chamber to direct the functionalized graphene particles toward the output filter and thereby aid in the collection of the particles.

Operation and use of the plasma reactor of FIG. 7 is as follows. Functionalizing gas is introduced into the reactor chamber through one or more of the inlet ports 123, 124, 126. As discussed above, different gases can be employed to impart different functions to the graphene particles in different sections of the chamber. Electrodes 118 are then energized to ionize the gas(es) and form one or more functionalizing plasmas in the chamber.

Graphene particles 99 are introduced into the reactor through hopper 98 and grinder 101, with the smaller particles dropping through inlet filter 103 and the larger particles being diverted through discharge chute 106 where they are collected and returned to the hopper.

The particles passing through the filter continue to fall vertically between the electrodes and through the plasma in the chamber. The residence time of the particles in the plasma is determined primarily by the height of the tower or length of the chamber, and vibrators 117 prevent the particles from adhering to the chamber walls.

When the particles reach the bottom of the chamber, the smaller ones pass through outlet filter 111 and outlet 112 where they are collected. Particles that are too big to pass through the filter exit the chamber through outlet 113. Thus, the particles are separated or classified according to size.

If deagglomeration of graphene clusters is necessary, a cryogenic gas can be introduced into the chamber through cryogenic port 128 to cool the chamber and, together with the high voltage applied to the electrodes, break up the clusters without further disintegration of the particles. If deagglomeration is not needed, the cryogenic port remains closed, and the gas is not used.

If the graphene is in discrete layers with random orientation, the high DC voltage in the chamber can also produce a delamination of the particles by generating heat between the layers or by applying an instantaneous different charge to the layers that causes them to separate. The Van De Whals forces are not strong enough to keep the particles together.

If needed, a liquid can be introduced through injection port 129 to flush the functionalized, deagglomerated, and/or delaminated graphene particles through the outlet filter for separation or classification by size.

In another embodiment, the reactor could have a torroidal shape, and the material to be functionalized could be spun continuously through the torroidal chamber and the plasma formed therein. This embodiment can have all of the features of the vertical reactor, but the residence time of the particles in the plasma is not limited by the length of the reactor and can be whatever is needed or desired.

The invention has a number of important features and advantages. It provides graphenes that are highly purified and functionalized. The process is highly scalable and capable of producing graphene on a commercial scale. The combination of washing, heating, and drying the graphene particles results in a product having a purity greater than 99 percent, and with the long, vertical reactor, the graphene particles can be functionalized in different ways by different plasmas as they drop through the reactor. The reactor also has the ability to deagglomerate and/or delaminate the graphene particles and expose more surface area to the plasma. It also serves as a particle separator in which the functionalized particles are separated or classified according to size.

It is apparent from the foregoing that a new and improved system and process for functionalizing graphene have been provided. While only certain presently preferred embodiments have been described in detail, as will be apparent to those familiar with the art, certain changes and modifications can be made without departing from the scope of the invention, as defined by the following claims.

1. A process for functionalizing graphene particles, comprising the steps of: separating and purifying the graphene particles, drying the graphene particles to open reactive sites on them, and functionalizing the graphene particles in an ionized gas plasma.

2. The process of claim 1 wherein the graphene particles are functionalized by introducing the graphene particles into the upper portion of a vertically elongated reaction chamber, introducing functionalizing gas into the chamber, and ionizing the gas to form a plasma that causes the functionalizing gas to adhere to the reactive sites as the particles drop through the chamber.

3. The process of claim 2 wherein different functionalizing gases are introduced into different regions of the chamber and ionized to form different plasmas that functionalize the reactive sites in different ways, with different gases becoming attached to the reactive sites as the particles drop through the different regions of the chamber.

4. The process of claim 2 including the step of introducing a cryogenic gas into the chamber to cool the reactor, deagglomerate graphene clusters, and increase the surface area of the graphene that is exposed to the plasma and functionalized.

5. The process of claim 2 wherein the functionalizing gas is ionized by a high DC voltage which also causes delamination of the graphene particles in the chamber.

6. The process of claim 5 including the steps of filtering the graphene particles introduced into the upper portion of the chamber, allowing particles smaller than a predetermined size to enter the chamber, and diverting particles larger than the predetermined size away from the chamber.

7. The process of claim 6 including the steps of grinding the particles before they are filtered and regrinding the particles diverted away from the chamber.

8. The process of claim 2 including the step of separating the functionalized graphene particles leaving the chamber according to size.

9. The process of claim 1 wherein a functionalizing gas is selected from the group consisting of oxygen, nitrogen, water vapor, hydrogen peroxide, carbon dioxide, ammonia, ozone, carbon monoxide, silane, dimethysilane, trimethylsilane, tetraetoxysilane, hexamethyldisioxane, chloro-silanes, fluoro-silanes, ethylene diamine, maleic anhydride, arylamine, acetylene, methane, ethane, propane, butane, ethylene oxide, hydrogen, air, sulfur dioxide, hydrogen, sulfonyl precursors, argon, helium, alcohols, methanol, ethanol, propanol, carbon tetrafluoride, carbon tetrachloride, carbon tetrabromide, chlorine, fluorine, bromine, and combinations thereof.

10. The process of claim 1 wherein the graphene particles are produced by combusting magnesium (Mg) with carbon dioxide (CO2) in a highly exothermic reaction.

11. The process of claim 10 wherein the graphene particles are separated and purified by washing carbon graphenes and magnesium oxide (MgO) particles with deionized water (H2O) and hydrochloric acid (HCl) to form an aqueous solution of magnesium chloride (MgCl2) with carbon graphenes in the solution, filtering the aqueous solution and graphenes to separate the graphenes and the MgCl2, heating the graphenes to a temperature on the order of 90° C. to dry them, heating the dried graphenes to a temperature on the order of 1600° C. to purify them, washing the purified graphenes in HCl and water, filtering the washed graphenes to separate them according to size, and drying the filtered graphenes at a temperature on the order of 90° C.

12. The process of claim 11 including the step of further purifying the filtered and dried graphenes by maintaining them at temperatures ranging from about 800° C. to about 1600° C. for a period of time ranging from about one half hour to as many hours as desired.

13. The process of claim 12 wherein the filtered and dried graphenes are placed in boats that are passed through an oven in stepwise fashion.

14. The process of claim 13 wherein the boats are pushed through the oven inside a tube that passes through the oven, with an inert gas atmosphere within the boats and tube to prevent combustion of the graphenes in the boats.

15. The process of claim 10 wherein the graphene particles are separated and purified by circulating hydrochloric acid (HCL) about a loop that includes a solids/liquids mixing reservoir and an inline static mixer, introducing carbon graphenes and magnesium oxide (MgO) particles into the circulating HCl in the mixing reservoir so that the graphenes and MgO particles circulate about the loop with the HCl and are washed by it, filtering the HCl solution to separate the graphenes from the HCl and MgO, washing the separated graphenes with deionized water, and drying the separated graphenes.

16. The process of claim 17 wherein the separated graphenes are dried initially with pressurized air and then further dried in an oven.

17. The process of claim 16 including the step of further purifying the separated and dried graphenes by maintaining them at temperatures ranging from about 800° C. to about 1600° C. for a period of time ranging from about one half hour to as many hours as desired.

18. The process of claim 17 wherein the separated and dried graphenes are placed in boats that are passed through an oven in stepwise fashion.

19. The process of claim 18 wherein the boats are pushed through the oven inside a tube that passes through the oven, with an inert gas atmosphere within the boats and tube to prevent combustion of the graphenes in the boats.

20. The process of claim 10 wherein the graphene particles are separated and purified by washing graphene and magnesium oxide (MgO) particles in hydrochloric acid (HCl) in a mixing reservoir, filtering the solution from the mixing reservoir to separate the graphene particles from the MgO and HCl, and drying the graphene particles.

21. The process of claim 20 wherein the graphene particles are dried initially with pressurized air and then further dried in an oven.

22. The process of claim 20 including the step of further purifying the separated and dried graphenes by maintaining them at temperatures ranging from about 800° C. to about 1600° C. for a period of time ranging from about one half hour to as many hours as desired.

23. The process of claim 22 wherein the separated and dried graphenes are placed in boats that are pushed through an oven in stepwise fashion.

24. The process of claim 23 wherein the boats are pushed through the oven inside a tube that passes through the oven, with an inert gas atmosphere within the boats and tube to prevent combustion of the graphenes in the boats.

25. The process of claim 10 wherein the graphene particles are separated and purified by treating graphene and magnesium oxide (MgO) particles ultrasonically in deionized water, washing the ultrasonically treated particles in hydrochloric acid (HCl) to form an aqueous solution of magnesium chloride (MgCl2) with carbon graphenes in the solution, filtering the aqueous solution to separate the graphenes, and drying the graphenes.

26. The process of claim 25 wherein the graphenes are recycled back through the sonification, filtering, and drying steps to further purify them.

27. The process of claim 25 including the step of further purifying the separated and purified graphenes by maintaining them at temperatures ranging from about 800° C. to about 1600° C. for a period of time ranging from about one half hour to as many hours as desired.

28. The process of claim 27 wherein the separated and purified graphenes are placed in boats that are pushed through an oven in stepwise fashion.

29. The process of claim 28 wherein the boats are pushed through the oven inside a tube that passes through the oven, with an inert gas atmosphere within the boats and tube to prevent combustion of the graphenes in the boats.

30. A system for functionalizing graphene particles, comprising means for separating and purifying the graphene particles, means for drying the graphene particles to open reactive sites on them, and a plasma reactor for functionalizing the graphene particles in an ionized gas plasma.

31. The system of claim 30 wherein the means for separating and purifying the graphene particles comprises means for washing carbon graphenes and magnesium oxide (MgO) particles with deionized water (H2O) and hydrochloric acid (HCl) to form an aqueous solution of magnesium chloride (MgCl2) with carbon graphenes in the solution, means for filtering the aqueous solution to separate the graphenes and the MgCl2, means for heating the graphenes to a temperature on the order of 90° C. to dry them, means for heating the dried graphenes to a temperature on the order of 1600° C. to purify them, means for washing the purified graphenes in HCl and water, means for filtering the washed graphenes to separate them according to size, and means for drying the filtered graphenes at a temperature on the order of 90° C.

32. The system of claim 30 wherein the means for separating and purifying the graphene particles comprises a solids/liquids mixing reservoir and an inline static mixer connected in a loop, means for circulating carbon graphenes and magnesium oxide (MgO) particles about the loop in hydrochloric acid (HCL) to wash the graphenes and the MgO particles, a filter for separating the graphenes from the HCl and MgO, means for washing the separated graphenes with deionized water, and means for drying the separated graphenes.

33. The system of claim 30 wherein the means for separating and purifying the graphene particles comprises a mixing reservoir where graphene and magnesium oxide (MgO) particles are washed in hydrochloric acid (HCl), means for filtering the solution from the mixing reservoir to separate the graphene particles from the MgO and HCl, and means for drying the graphene particles.

34. The system of claim 30 wherein the means for separating and purifying the graphene particles comprises means for treating graphene and magnesium oxide (MgO) particles ultrasonically in deionized water, means for washing the ultrasonically treated particles in hydrochloric acid (HCl) to form an aqueous solution of magnesium chloride (MgCl2) with carbon graphenes in the solution, means for filtering the aqueous solution to separate the graphenes, and means for drying the graphenes.

35. The system of claim 34 including means for recycling the graphenes recycled back through the sonification, filtering, and drying means to further purify them.

36. The system of claim 30 including means for maintaining the purified graphene particles at temperatures ranging from about 800° C. to about 1600° C. for a period of time ranging from about one half hour to as many hours as desired to further purify them.

37. The system of claim 36 wherein the means for maintaining the purified graphene particles at temperatures ranging from about 800° C. to about 1600° C. comprises a pusher oven having a heating cavity, a tube which passes through the cavity, and a plurality of boats which carry the graphene particles and are pushed through the tube in stepwise fashion.

38. The system of claim 37 further including means for maintaining an inert gas atmosphere within the boats and the tube to prevent combustion of the graphene particles in the boats.

39. The system of claim 29 wherein the plasma reactor comprises a vertically elongated reaction chamber, means for introducing the graphene particles into an upper portion of reaction chamber, means for introducing functionalizing gas into the chamber, and means for ionizing the gas to form a plasma that causes the functionalizing gas to adhere to the reactive sites as the particles drop through the chamber.

40. The system of claim 38 wherein the means for introducing functionalizing gas into the chamber includes means for introducing different functionalizing gases into different regions of the chamber, with the different gases being ionized to form different plasmas that functionalize the reactive sites in different ways, with different gases becoming attached to the reactive sites as the particles drop through the different regions of the chamber.

41. The system of claim 39 wherein the means for ionizing the gas includes a plurality of vertically elongated, laterally spaced apart electrodes disposed within the chamber, and means for energizing the electrodes to ionize the gas.

42. The system of claim 41 including means for introducing a cryogenic gas into the chamber to cool the reactor, promote deagglomeration of graphene clusters, and increase the surface area of the graphene that is exposed to the plasma and functionalized.

43. The system of claim 39 including means for delaminating graphene particles in the chamber.

44. The system of claim 40 wherein the means for introducing the graphene particles into the upper portion of reaction chamber includes a grinder through which the particles are passed, a filter between the grinder and the upper portion of the chamber which allows particles smaller than a predetermined size to enter the chamber, and means for returning particles larger than the predetermined size to the grinder for further processing.

45. The system of claim 39 including a filter for separating functionalized graphene particles leaving the chamber according to size.

46. The system of claim 39 a vertical height or length on the order of 100 feet, or more, and a diameter on the order of about 2 to 6 inches.

47. The system of claim 38 wherein the reaction chamber has a generally cylindrical side wall, with a vibrator for preventing particles from adhering to the wall.

48. The system of claim 30 wherein a functionalizing gas selected from the group consisting of oxygen, nitrogen, water vapor, hydrogen peroxide, carbon dioxide, ammonia, ozone, carbon monoxide, silane, dimethysilane, trimethylsilane, tetraetoxysilane, hexamethyldisioxane, chloro-silanes, fluoro-silanes, ethylene diamine, maleic anhydride, arylamine, acetylene, methane, ethane, propane, butane, ethylene oxide, hydrogen, air, sulfur dioxide, hydrogen, sulfonyl precursors, argon, helium, alcohols, methanol, ethanol, propanol, carbon tetrafluoride, carbon tetrachloride, carbon tetrabromide, chlorine, fluorine, bromine, and combinations thereof is introduced into the chamber and ionized to form a plasma for functionalizing the reactive sites on the graphene particles.
